(19) United States
(12) Patent Application Publication
(10) Pub. No.: US 2023/0119702 A1
(43) Pub. Date: Apr. 20, 2023

(54) LEACHATE PROCESSING SYSTEM

(71) Applicant: Moran Environmental Recovery, LLC, Randolph, MA (US)

(72) Inventors: Edward Maylon, Jacksonville, FL (US); Amanda Kimball, Jacksonville, FL (US)

(21) Appl. No.: 17/506,121

(22) Filed: Oct. 20, 2021

(51) Int. Cl. C02F 1/44; C02F 9/00; C02F 1/00

(52) U.S. Cl. CPC C02F 1/444; C02F 9/00; C02F 1/441; C02F 1/442; C02F 1/001; C02F 2103/06

(57) ABSTRACT

A system for processing leachate is provided. The system has an ultrafiltration unit that receives the leachate and produces both an ultrafiltration permeate and an ultrafiltration reject. The system recovers the ultrafiltration reject and recirculates it through the ultrafiltration unit to produce a combined ultrafiltration permeate. The system also has a nanofiltration unit that receives the combined ultrafiltration permeate and produces both a nanofiltration permeate and a nanofiltration reject. The system also has a carbon filtration system that receives the nanofiltration reject and produces a carbon filtration permeate. The system also has a system output that receives the nanofiltration permeate and the carbon filtration permeate and produces a mixture of both permeates as an output mixture.

### FIELD

Disclosed embodiments are related to systems and methods for the processing of leachate.

### BACKGROUND

Leachate may be treated using various processes, including but not limited to filtration. Ultrafiltration, nanofiltration, or a combination of ultrafiltration and nanofiltration process may be used in the treatment of leachate. Leachate filtration systems may remove contaminants that may otherwise inhibit the effectiveness of subsequent treatment methods, such as ultraviolet treatment, which may be employed to convert the filtered leachate into potable water.

### SUMMARY

In some embodiments, a method of processing leachate comprises filtering the leachate through an ultrafiltration unit to produce an ultrafiltration permeate. The ultrafiltration permeate is filtered through a nanofiltration unit to produce a nanofiltration permeate and a nanofiltration reject. The nanofiltration reject is filtered through a carbon filtration system to produce a carbon filtration permeate. The carbon filtration permeate is mixed with the nanofiltration permeate to produce an output mixture.

In other embodiments, a method of processing leachate comprises filtering the leachate through an ultrafiltration unit to produce an ultrafiltration permeate and an ultrafiltration reject. The ultrafiltration reject is recovered and recirculated through the ultrafiltration unit to produce a combined ultrafiltration permeate. The combined ultrafiltration permeate is filtered through a nanofiltration unit to produce a nanofiltration permeate.

In other embodiments, a system for the processing of leachate comprises an ultrafiltration unit. The ultrafiltration unit is configured to receive the leachate, produce an ultrafiltration permeate and an ultrafiltration reject, and recover the ultrafiltration reject and recirculate the ultrafiltration reject through the ultrafiltration unit to produce a combined ultrafiltration permeate. The system additionally comprises a nanofiltration unit configured to receive the combined ultrafiltration permeate and produce a nanofiltration permeate and a nanofiltration reject, and a carbon filtration system configured to receive the nanofiltration reject and produce a carbon filtration permeate. The system also comprises a system output configured to receive the nanofiltration permeate from the nanofiltration unit and the carbon filtration permeate from the carbon filtration system and to produce an output mixture comprising the nanofiltration permeate and the carbon filtration permeate.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic diagram showing one embodiment of a system for processing leachate;

FIG. 2 is a process diagram showing a method of processing leachate according to a first embodiment;

FIG. 3 is a process diagram showing a method of processing leachate according to a second embodiment; and

FIG. 4 is a process diagram showing a method of processing leachate according to a third embodiment.

### DETAILED DESCRIPTION

To be made suitable for various applications, water may be subjected to one or more treatment processes to remove contaminants or other unwanted substances. For example, ultraviolet (UV) radiation treatment is often used to disinfect water or leachate at water treatment plants, such as publicly owned treatment works (POTWs). UV treatment may be used as part of a process to convert non-potable water or leachate into potable water. Higher levels of UV transmittance (UVT) may be associated with more effective and/or efficient treatment of the water, as the UV rays are able to penetrate more deeply into the volume of water. Accordingly, it is often desirable that the water or leachate to be treated have a UVT above a minimum threshold.

However, the UVT of leachate is often insufficient to allow for effective UV treatment, due to the presence of dissolved solid and colloidal contaminants which block the UV penetration. Therefore, these contaminants are often filtered from a volume of leachate prior to subsequent treatment (such as, but not limited to, UV treatment) at a treatment facility such as a POTW.

Conventional water and leachate treatment systems may include different arrangements using various treatment methods such as biological treatments, chemical treatments, electrochemical treatments, or physical treatments including ultrafiltration, nanofiltration, or reverse osmosis. For example, a conventional system may include one or more ultrafiltration units arranged in series with one or more nanofiltration units. The ultrafiltration unit may be configured to remove larger suspended solids. The nanofiltration unit may be configured to remove smaller dissolved solids as well as organic material. Each filtration unit may accept one or more supply stream and may separate the supply into a permeate and a reject. The permeate may be the portion of the supply that passes through the filtration unit, while the reject may be the portion of the supply that is captured by the filtration unit.

Some conventional systems that utilize an ultrafiltration process followed by a nanofiltration filtration process can filter contaminants from a volume of water or leachate to produce a nanofiltration permeate with a high UVT. In some cases, the nanofiltration permeate may have a UVT of up to 100%. However, when used with leachate, ultrafiltration/nanofiltration systems may be inefficient. In some cases, as little as 70% of the total volume of leachate is recovered as nanofiltration permeate, resulting in up to 30% of the supply leachate volume being disposed of as waste. For example, as much as 15% of the volume of supply leachate may be rejected by the ultrafiltration process as ultrafiltration reject, and up to an additional 15% may be rejected by the nanofiltration process as nanofiltration reject.

In view of the above limitations of conventional leachate processing systems, the inventors have recognized the benefits associated with further processing the rejected volumes of the ultrafiltration and/or nanofiltration processes to increase the volume of output, resulting in a more efficient leachate processing system. For example, the ultrafiltration reject is recovered from the ultrafiltration unit and recirculated back through the ultrafiltration unit. Additionally or alternatively, the nanofiltration reject is directed to a carbon filtration system for further filtration. The systems and processes disclosed herein may increase the volume of leachate recovered without degrading the UVT of the final output mixture below a level that would be desirable for effective UV treatment. In some embodiments, processing the ultrafiltration and/or nanofiltration reject may enable recovery of up to 99% of the volume of supply leachate. In some embodiments, the output mixture may have a UVT of at least 90%.

In some embodiments, the ultrafiltration reject is recovered from the ultrafiltration unit and recirculated back through the ultrafiltration unit via a reject recovery stream to produce a combined ultrafiltration permeate. In some embodiments, the ultrafiltration reject may be recovered directly from one or more ultrafiltration filters within the ultrafiltration unit and delivered into the reject recovery stream. The reject recovery stream may be mixed with a supply stream of supply leachate prior to reentering the ultrafiltration unit, or the reject recovery stream may be mixed with the supply stream at a point of entry into the ultrafiltration unit. The reject recovery stream may also be mixed with the supply stream at a point internal to the ultrafiltration unit. The recovery and supply streams may be segregated within the ultrafiltration unit until a point of filtration. The recovery and supply streams may have different flow rates and properties (e.g., viscosity, contamination levels, UVT, or others). The recovered ultrafiltration reject may also be stored, such as in a holding tank as described below, for subsequent processing. It should be appreciated that the supply stream and the reject recovery stream may operate continuously, simultaneously, and independently of one another, such that operation of one stream does not constrain operation of the other. It should be further appreciated that the combined ultrafiltration permeate is not limited to any particular ratio of volumes recovered from the supply stream and the reject recovery stream. It should be understood that the term “ultrafiltration permeate” is a general term that may include permeate recovered from the supply stream, permeate recovered from the reject recovery stream, or the combination of permeate recovered from the supply stream and permeate recovered from the reject recovery stream which is specifically referred to herein as “combined ultrafiltration permeate”.

The ultrafiltration and nanofiltration units may each include multiple stages of filtration. Stages may be arranged in parallel or in series, or there may be a combination of parallel and serial stages. The reject recovery stream may be returned to the ultrafiltration unit at any appropriate point, including at any stage of filtration. For example, the reject recovery stream may bypass a first filtering stage that only accepts the supply stream. The reject recovery stream may also be processed through the ultrafiltration unit in parallel with the supply stream, such that the streams are not mixed until each has been processed through the ultrafiltration unit.

In some embodiments, a nanofiltration reject is directed to a carbon filtration system for further filtration. The carbon filtration system may filter out organic material that may be present in the nanofiltration reject. A permeate from the carbon filtration system may have a UVT that is lower than the UVT of the nanofiltration permeate. In some embodiments, the carbon filtration permeate may have a UVT as low as 60%.

The carbon filtration permeate may be mixed with the nanofiltration permeate to produce an output mixture. In some embodiments, the UVT of the carbon filtration permeate may be lower than would be desirable for certain UV treatment processes. However, the carbon filtration permeate may be mixed with the nanofiltration permeate to produce an output mixture such that the UVT of the mixture is suitable for effective UV treatment. As would be appreciated by one of skill in the art, appropriate volumes of carbon filtration permeate and nanofiltration permeate may be mixed according to the respective UVT of the carbon filtration permeate and the nanofiltration permeate, as well as the desired UVT of the output mixture. Without wishing to be bound by theory, a UVT of an output mixture may be a weighted average of the UVT of the carbon filtration permeate and the nanofiltration permeate (wherein the average is weighted according to the relative volumes of carbon filtration permeate and the nanofiltration permeate). Additionally, because the carbon filtration system may recover a significant portion of the nanofiltration reject that would previously have been discarded, the addition of a carbon filtration system allows the leachate processing system to recover a higher proportion of leachate. For example, the carbon filtration permeate may be mixed with the nanofiltration permeate to recover a volume of output mixture that may be 99% of the initial volume of supply leachate, and the UVT of this output mixture may still be greater than 90%. Generally, the addition of a carbon filtration system may be associated with a higher overall recovery rate while ensuring an output UVT above a predetermined threshold.

In some embodiments, the carbon filtration system may include a plurality of flow paths arranged in parallel. The parallel flow paths may operate independently of one another, such that one or more flow paths may be disengaged from the system for maintenance or repairs without disrupting system performance. In some embodiments, a single flow path may have sufficient capacity to maintain full operational capacity while other flow paths are not in use.

In some embodiments, the carbon filtration system may include multiple phases of filtration arranged in series. In embodiments with two phases, the first phase may produce around 40% of the total carbon filtration reject, while the second phase may produce around 60% of the total carbon filtration reject. Alternatively, each of two phases may produce about 50% of the carbon filtration reject. In some embodiments, more than two phases may be present. In embodiments with parallel flow paths, each individual flow path may include multiple phases as described.

The carbon filtration system may utilize a suitable weight of activated carbon. The activated carbon may be granular activated carbon, or any other appropriate form of activated carbon. In some embodiments, a carbon filtration system may utilize a weight of activated carbon that is greater than or equal to 500, 1000, 2000, or 4000 pounds. In some embodiments, a carbon filtration system may utilize a weight of activated carbon that is less than or equal to 15,000, 10,000, 8000, or 4000 pounds. Combinations of the above values are also contemplated. For example, a carbon filtration system may utilize a weight of activated carbon that is greater than 2000 pounds and less than 10,000 pounds, or greater than 4000 pounds and less than 8000 pounds. It should be appreciated that any suitable weight of activated carbon may be utilized in a carbon filtration system, as the disclosure is not limited in this regard.

The carbon filtration system may have a suitable flow rate capacity. In some embodiments, a carbon filtration system may have a flow rate capacity that is greater than or equal to 25, 50, 100, or 150 gallons per minute. In some embodiments, a carbon filtration system may have a flow rate capacity that is less than or equal to 500, 300, 250, or 200 gallons per minute. Combinations of the above values are also contemplated. For example, a carbon filtration system may have a flow rate capacity that is greater than 100 gallons per minute and less than 300 gallons per minute, or greater than 150 gallons per minute and less than 250 gallons per minute. It should be appreciated that any suitable flow rate capacity may be utilized in a carbon filtration system, as the disclosure is not limited in this regard.

The ultrafiltration and/or nanofiltration system may have a suitable flow rate capacity. In some embodiments, the ultrafiltration and/or nanofiltration system may have a flow rate capacity that is greater than or equal to 150, 200, 250, or 300 gallons per minute. In some embodiments, an ultrafiltration and/or nanofiltration system may have a flow rate capacity that is less than or equal to 750, 500, 350, or 300 gallons per minute. Combinations of the above values are also contemplated. For example, an ultrafiltration and/or nanofiltration system may have a flow rate capacity that is greater than 200 gallons per minute and less than 500 gallons per minute, or greater than 300 gallons per minute and less than 350 gallons per minute. It should be appreciated that any suitable flow rate capacity may be utilized in an ultrafiltration and/or nanofiltration system, as the disclosure is not limited in this regard.

In some embodiments, the leachate processing system may include a plurality of holding tanks. A holding tank may be configured to store a material after processing or prior to further processing, or both. For example, a holding tank downstream of a filter may be configured to receive the permeate or the reject from the filter. In some embodiments, a holding tank may be configured to contain the supply leachate prior to ultrafiltration. In some embodiments, a holding tank may be configured to contain the nanofiltration permeate after nanofiltration and prior to mixing with the carbon filtration permeate. In some embodiments, a holding tank may be configured to contain the output mixture or nanofiltration permeate prior to delivering it to a delivery destination, such as a POTW.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

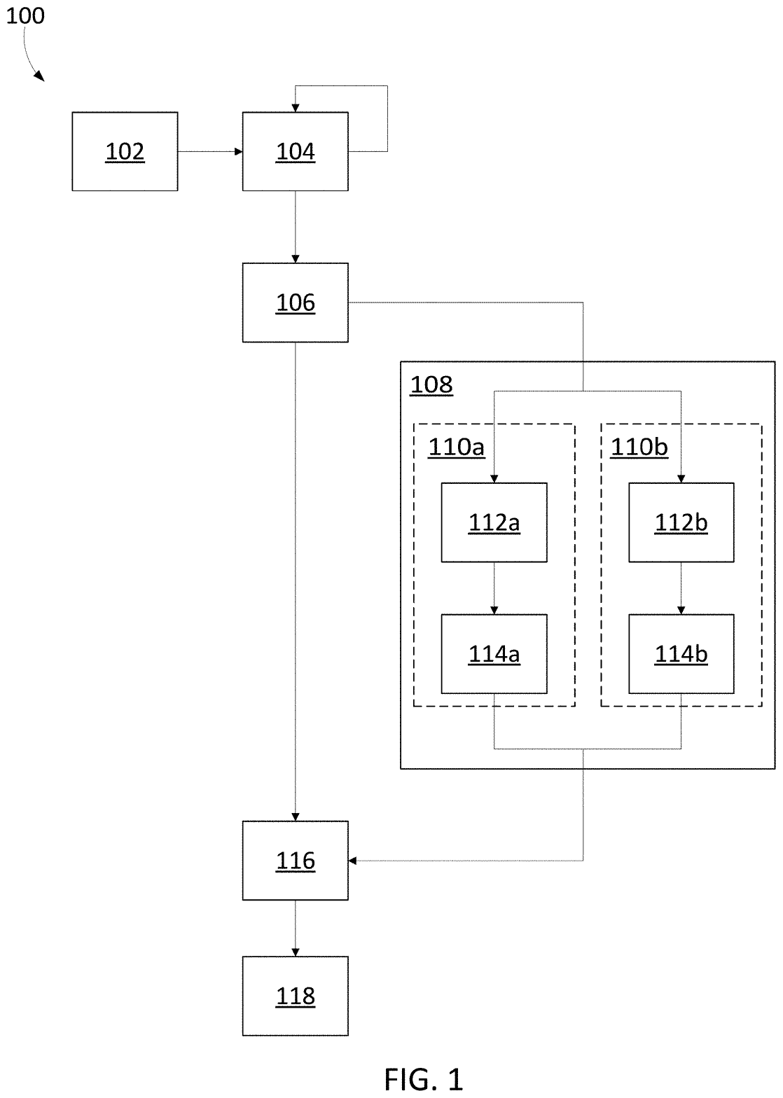

FIG. 1 is a schematic diagram showing one embodiment of a leachate processing system 100. The leachate processing system 100 includes a supply leachate source 102, which may include a holding tank, a pipe or pipeline including any suitable number and/or arrangement of pumps and valves, or any other suitable source of leachate. In the system shown, leachate is delivered from the supply leachate source 102 to an input of an ultrafiltration unit 104. The ultrafiltration unit 104 includes at least one input and at least one output. The ultrafiltration unit 104 is configured to discharge an ultrafiltration reject and an ultrafiltration permeate. The ultrafiltration reject and the ultrafiltration permeate may be discharged through the same output of the ultrafiltration unit 104, or through distinct outputs. For example, the ultrafiltration reject may be discharged through an ultrafiltration reject output while the ultrafiltration permeate may be discharged through an ultrafiltration permeate output. The ultrafiltration unit 104 is configured to allow recovery and recirculation of the ultrafiltration reject, as described above.

An output of the ultrafiltration unit 104 (e.g., an ultrafiltration permeate output) is operatively coupled to an input of a nanofiltration unit 106. The nanofiltration unit 106 includes at least one input and at least one output. The nanofiltration unit 106 is configured to discharge a nanofiltration reject and a nanofiltration permeate. The nanofiltration reject and the nanofiltration permeate may be discharged through the same output of the nanofiltration unit 106, or through distinct outputs. For example, the nanofiltration reject may be discharged through a nanofiltration reject output while the nanofiltration permeate may be discharged through a nanofiltration permeate output.

An output of nanofiltration unit 106 (e.g., a nanofiltration permeate output) is operatively coupled to a system output 116. The same output or a different output of the nanofiltration unit 106 is operatively coupled to a carbon filtration system 108. For example, a nanofiltration reject output may be operatively coupled to the carbon filtration system 108. The carbon filtration system 108 includes at least one input and at least one output. The carbon filtration system 108 is configured to discharge a carbon filtration reject and a carbon filtration permeate. The carbon filtration reject and the carbon filtration permeate may be discharged through the same output of the carbon filtration system 108, or through distinct outputs. In the embodiment of FIG. 1, the carbon filtration system 108 is divided into parallel carbon filtration flow paths 110a and 110b. Each of the carbon filtration flow paths includes first and second carbon filtration phases. Specifically, a first carbon filtration flow path 110a includes a first carbon filtration phase 112a and a second carbon filtration phase 114a arranged in series with the first carbon filtration phase 112a. A second carbon filtration flow path 110b includes a first carbon filtration phase 112b and a second carbon filtration phase 114b arranged in series with the first carbon filtration phase 112b. The outputs of the first and second carbon filtration flow paths 110a and 110b may be combined prior to discharge from the carbon filtration system 108. It should be appreciated that other carbon filtration systems may be appropriate in a leachate processing system. For example, a carbon filtration system may include different numbers and/or arrangements of flow paths and/or phases, as described above.

An output of the carbon filtration system 108 is operatively coupled to the system output 116. In some embodiments, the system output 116 may be a flow path. The system output 116 may include a pipe system wherein a pipe carrying the carbon filtration permeate may be configured to converge with a pipe carrying the nanofiltration permeate, thereby mixing the respective permeates to produce an output mixture within the pipe system. The system output 116 may include one or more holding tanks as described above. A holding tank may be configured to receive the nanofiltration permeate from the nanofiltration unit 106. Additionally or alternatively, a holding tank may be configured to receive the carbon filtration permeate from the carbon filtration system 108. Additionally or alternatively, a holding tank may be configured to receive the nanofiltration permeate from the nanofiltration unit 106 and the carbon filtration permeate from the carbon filtration system 108, such that the permeates are mixed to produce an output mixture within the holding tank. Mixing within a holding tank may be facilitated by a mixing mechanism, such as a paddle, an agitator, or turbulence-inducing structures.

The system output 116 is operatively coupled to a delivery destination 118. The delivery destination 118 may be a downstream facility configured to receive the output mixture for further processing, including any UV treatment, biological treatment, chemical treatment, electrochemical treatment, or further physical treatment required to convert the output mixture into a desired product such as potable water.

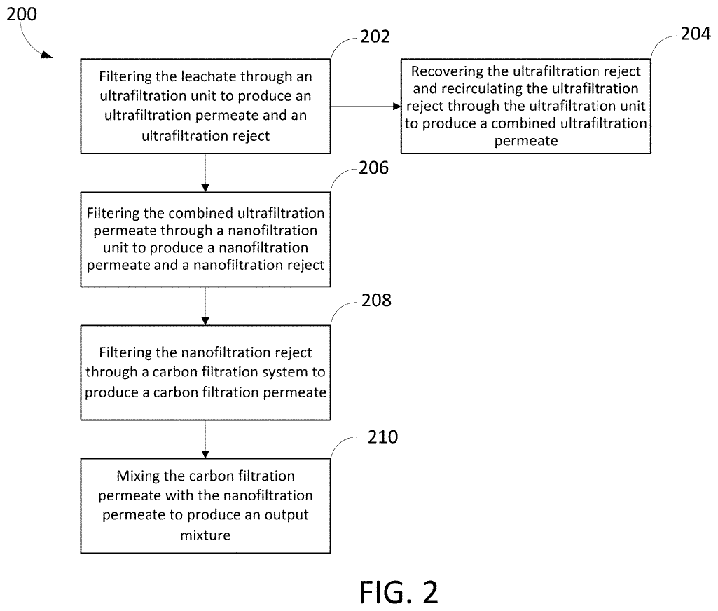

FIG. 2 illustrates a process diagram of one embodiment of a method 200 for processing leachate. In block 202, the leachate is filtered through an ultrafiltration unit to produce an ultrafiltration permeate and an ultrafiltration reject. In block 204, the ultrafiltration reject is recovered and recirculated through the ultrafiltration unit to produce a combined ultrafiltration permeate. In block 206, the combined ultrafiltration permeate is filtered through a nanofiltration unit to produce a nanofiltration permeate and a nanofiltration reject. The nanofiltration permeate may be configured for UV treatment. The nanofiltration permeate may have a UVT of up to 100%. The volume of the nanofiltration permeate may be at least 70% of the initial volume of supply leachate, and at least 85% of the volume of ultrafiltration reject.

In block 208, the nanofiltration reject is filtered through a carbon filtration system to produce a carbon filtration permeate. The carbon filtration system may include a plurality of flow paths arranged in parallel. Each flow path may include a series of carbon filtration phases. In block 210, the carbon filtration permeate is mixed with the nanofiltration permeate to produce an output mixture. This mixing may occur in a flow path that includes one or more holding tanks. A total volume of the output mixture may be at least 99% of a volume of the leachate, and the output mixture may be configured for UV treatment. A UVT of the output mixture may be at least 90%. The volume of nanofiltration permeate may comprise 85% of the volume of the output mixture.

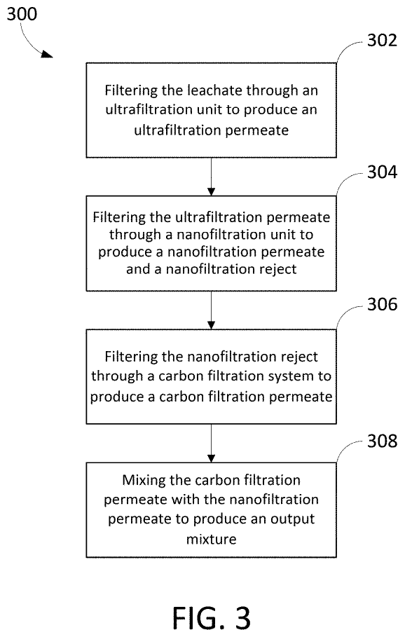

FIG. 3 illustrates a process diagram of one embodiment of a method 300 for processing leachate. In block 302, the leachate is filtered through an ultrafiltration unit to produce an ultrafiltration permeate. In block 304, the ultrafiltration permeate is filtered through a nanofiltration unit to produce a nanofiltration permeate and a nanofiltration reject. The nanofiltration permeate may be configured for UV treatment. The nanofiltration permeate may have a UVT of up to 100%. The volume of the nanofiltration permeate may be at least 70% of the initial volume of leachate, and at least 85% of the volume of ultrafiltration reject.

In block 306, the nanofiltration reject is filtered through a carbon filtration system to produce a carbon filtration permeate. The carbon filtration system may include a plurality of flow paths arranged in parallel. Each flow path may comprise a series of carbon filtration phases. In block 308, the carbon filtration permeate is mixed with the nanofiltration permeate to produce an output mixture. This mixing may occur in a flow path that includes one or more holding tanks. A total volume of the output mixture may be at least 99% of a volume of the leachate, and the output mixture may be configured for UV treatment. A UVT of the output mixture may be at least 90%. The volume of nanofiltration permeate may comprise 85% of the volume of the output mixture.

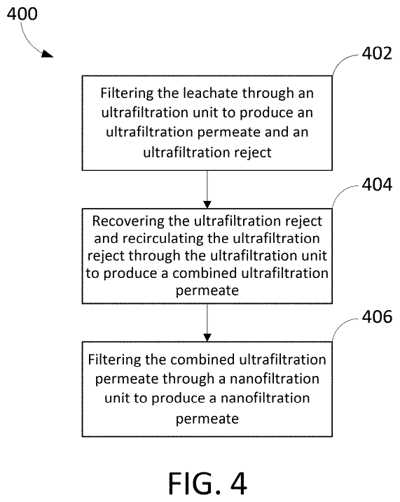

FIG. 4 illustrates a process diagram of one embodiment of a method 400 for processing leachate. In block 402, the leachate is filtered through an ultrafiltration unit to produce an ultrafiltration permeate and an ultrafiltration reject. In block 404, the ultrafiltration reject is recovered and recirculated through the ultrafiltration unit to produce a combined ultrafiltration permeate.

In block 406, the combined ultrafiltration permeate is filtered through a nanofiltration unit to produce a nanofiltration permeate. The nanofiltration permeate may be configured for UV treatment. The nanofiltration permeate may have a UVT of up to 100%. The volume of the nanofiltration permeate may be at least 70% of the initial volume of leachate, and at least 85% of the volume of ultrafiltration reject.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A method of processing leachate, the method comprising:
filtering the leachate through an ultrafiltration unit to produce an ultrafiltration permeate;
filtering the ultrafiltration permeate through a nanofiltration unit to produce a nanofiltration permeate and a nanofiltration reject;
filtering the nanofiltration reject through a carbon filtration system to produce a carbon filtration permeate; and
mixing the carbon filtration permeate with the nanofiltration permeate to produce an output mixture.

2. The method of claim 1, wherein filtering the nanofiltration reject through a carbon filtration system to produce a carbon filtration permeate comprises filtering the nanofiltration reject through a carbon filtration system comprising at least one carbon filtration flow path, wherein the at least one carbon filtration flow paths comprises a first phase of carbon filtration and a second phase of carbon filtration, the first and second phases being arranged in series.

3. The method of claim 2, wherein filtering the nanofiltration reject through a carbon filtration system comprising at least one carbon filtration flow path comprises directing flow to at least one of a first carbon filtration flow path and a second carbon filtration flow path arranged in parallel with the first carbon filtration flow path.

4. The method of claim 1, wherein filtering the leachate through an ultrafiltration unit and producing an ultrafiltration permeate further comprises producing an ultrafiltration reject.

5. The method of claim 4, further comprising recovering the ultrafiltration reject and recirculating the ultrafiltration reject through the ultrafiltration unit.

6. The method of claim 1, wherein mixing the carbon filtration permeate with the nanofiltration permeate to produce an output mixture comprises mixing the carbon filtration permeate with the nanofiltration permeate to produce an output mixture wherein a total volume of the output mixture is at least 99% of a total volume of the leachate.

7. The method of claim 1, wherein mixing the carbon filtration permeate with the nanofiltration permeate to produce an output mixture comprises mixing the carbon filtration permeate with the nanofiltration permeate to produce an output mixture wherein 85% of the output mixture is the nanofiltration permeate.

8. The method of claim 1, wherein mixing the carbon filtration permeate with the nanofiltration permeate to produce an output mixture comprises mixing the carbon filtration permeate with the nanofiltration permeate to produce an output mixture configured for ultraviolet treatment.

9. The method of claim 8, wherein mixing the carbon filtration permeate with the nanofiltration permeate to produce an output mixture comprises mixing the carbon filtration permeate with the nanofiltration permeate to produce an output mixture with at least 90% ultraviolet transmittance.

10. A method of processing leachate, the method comprising:
filtering the leachate through an ultrafiltration unit to produce an ultrafiltration permeate and an ultrafiltration reject;
recovering the ultrafiltration reject and recirculating the ultrafiltration reject through the ultrafiltration unit to produce a combined ultrafiltration permeate; and
filtering the combined ultrafiltration permeate through a nanofiltration unit to produce a nanofiltration permeate.

11. The method of claim 10, wherein filtering the combined ultrafiltration permeate through a nanofiltration unit to produce a nanofiltration permeate further comprises producing a nanofiltration reject.

12. The method of claim 11, further comprising:
filtering the nanofiltration reject through a carbon filtration system and producing a carbon filtration permeate; and
mixing the carbon filtration permeate with the nanofiltration permeate to produce an output mixture.

13. The method of claim 12, wherein filtering the nanofiltration reject through a carbon filtration system to produce a carbon filtration permeate comprises filtering the nanofiltration reject through a carbon filtration system comprising at least one carbon filtration flow path, wherein the at least one carbon filtration flow paths comprises a first phase of carbon filtration and a second phase of carbon filtration, the first and second phases being arranged in series.

14. The method of claim 12, wherein filtering the nanofiltration reject through a carbon filtration system comprising at least one carbon filtration flow path comprises directing flow to at least one of a first carbon filtration flow path and a second carbon filtration flow path arranged in parallel with the first carbon filtration flow path.

15. The method of claim 12, wherein mixing the carbon filtration permeate with the nanofiltration permeate to produce an output mixture comprises mixing the carbon filtration permeate with the nanofiltration permeate to produce an output mixture, wherein a total volume of the output mixture is at least 99% of a total volume of the leachate.

16. The method of claim 12, wherein mixing the carbon filtration permeate with the nanofiltration permeate to produce an output mixture comprises mixing the carbon filtration permeate with the nanofiltration permeate to produce an output mixture configured for ultraviolet treatment.

17. The method of claim 12, wherein mixing the carbon filtration permeate with the nanofiltration permeate to produce an output mixture comprises mixing the carbon filtration permeate with the nanofiltration permeate to produce an output mixture with at least 90% ultraviolet transmittance.

18. A system for the processing of leachate, the system comprising:
an ultrafiltration unit configured to:
receive the leachate,
produce an ultrafiltration permeate and an ultrafiltration reject, and
recover the ultrafiltration reject and recirculate the ultrafiltration reject through the ultrafiltration unit to produce a combined ultrafiltration permeate;
a nanofiltration unit configured to receive the combined ultrafiltration permeate and produce a nanofiltration permeate and a nanofiltration reject;
a carbon filtration system configured to receive the nanofiltration reject and produce a carbon filtration permeate; and
a system output configured to receive the nanofiltration permeate from the nanofiltration unit and the carbon filtration permeate from the carbon filtration system and to produce an output mixture comprising the nanofiltration permeate and the carbon filtration permeate.

19. The system of claim 18, wherein the output mixture is configured for ultraviolet treatment.

20. The system of claim 18, wherein the carbon filtration system comprises at least one carbon filtration flow path, wherein each of the at least one carbon filtration flow paths comprises a first phase of carbon filtration and a second phase of carbon filtration, the first and second phases being arranged in series.

21. The system of claim 20, wherein the carbon filtration system comprises a first carbon filtration flow path and a second carbon filtration flow path arranged in parallel with the first carbon filtration flow path.
